(19) United States
(12) Patent Application Publication
(10) Pub. No.: US 2017/0253948 A1
(43) Pub. Date: Sep. 7, 2017

(54) HIGH-GRADE METHOD OF ILMENITE ORE, MANUFACTURING METHOD OF HIGH-GRADE TIO2 USING THE SAID METHOD AND HIGH-GRADE TIO2 PRODUCED BY THE SAID MANUFACTURING METHOD, FOR TI-RAW MATERIALS

(71) Applicant: TOHOKU UNIVERSITY, Sendai (JP)

(72) Inventors: Tetsuya NAGASAKA, Sendai-shi (JP); Yoshihiro ITO, Kobe (JP); Katsuyuki IIJIMA, Kobe (JP); Eiichiro YOSHIKAWA, Kobe (JP); Toru TAKAI, Amagasaki (JP); Nobuo NAKAMURA, Amagasaki (JP)

(73) Assignee: TOHOKU UNIVERSITY, Sendai (JP)

(21) Appl. No.: 15/435,674

(22) Filed: Feb. 17, 2017

(30) Foreign Application Priority Data
Feb. 18, 2016 (JP) 2016-029255

(51) Int. Cl. C22B 34/12; C01G 23/047

(52) U.S. Cl. CPC C22B 34/1213; C01G 23/0475; C01P 2006/80

(57) ABSTRACT

A method for upgrading an ilmenite ore for yielding a high-TiO₂-content titanium source by separating and removing an iron component from ilmenite (FeTiO₃), which includes an oxidation step of oxidizing a starting ilmenite; after the oxidation step, a reduction step of reducing the treated ilmenite; and after the reduction step, an extraction step of dissolving the iron component with an acid, to thereby remove the iron component. Also disclosed is a production method for producing a high-TiO₂-content titanium source, which includes upgrading an ilmenite ore as described above, and a high-TiO₂-content titanium source produced through the production method.

### FIELD OF THE INVENTION

The present invention relates to a method for upgrading an ilmenite ore (hereinafter may be referred to as an “ilmenite ore upgrading method”), to a method for producing a high-TiO₂-content titanium source (hereinafter may be referred to as a “high-TiO₂-content titanium source production method”) through the upgrading method, and to a high-TiO₂-content titanium source produced through the production method. More particularly, the invention relates to a method for producing a high-TiO₂-content ore by upgrading an ilmenite ore containing titanium and iron, and to a high-TiO₂-content titanium source produced through the production method.

### BACKGROUND OF THE INVENTION

Titanium is a lightweight material exhibiting excellent mechanical strength, heat resistance, and corrosion resistance, and having various properties such as non-magnetic property and high biocompatibility. Thus, metallic titanium or a titanium alloy is used in a variety of fields including aircraft materials, anti-corrosive materials of chemical industry equipment, medical apparatus, golf goods, and glasses frames.

Titanium is recovered from materials; naturally occurring rutile, synthetic rutile, and high-titanium slag. Specifically, metallic titanium is produced by chloridizing titanium oxide contained in such a material, and reducing the obtained chloride (titanium tetrachloride) with metallic magnesium (i.e., the Kroll process).

The raw material for titanium production contains oxides of Fe, Al, Si, Mn, or the like as impurities, and the impurities are separated as wastes in a purification step for titanium tetrachloride. From the viewpoints of waste reduction, it is desired the raw material for titanium production preferably has a high TiO₂ content (grade) (i.e., TiO₂≧93%), for environmental load reduction and production cost reduction. However, difficulty is encountered in gaining the raw material for high TiO₂-grade titanium production, from a commercial aspect (amount/cost in mining). In addition, the price of titanium has keenly risen in recent years, and further difficulty may be encountered in consistently securing titanium sources.

Under such circumstances, in conventionally employed TiO₂-upgrading methods, impurities are removed from a low-TiO₂-grade ilmenite ore (TiO₂: 30 to 65 mass %), which is an abundant source, by subjecting the ore to a wet leaching process (e.g., the Benilite process or the Beacher process) or a dry smelting (titanium slag process) (see, for example, Non-Patent Document 1).

Hitherto, the efficiency of such a wet leaching process has been studied, and examples thereof include a combination of an oxidation process and a reduction process, and a multi-step leaching process after oxidation. For example, Patent Document 1 discloses a method for producing a raw material for refining titanium, in which the raw material is to be subjected to upgrading through wet leaching, which method includes roasting a source of the raw material containing at least titanium oxide, iron oxide, and silicon oxide for refining titanium in an oxidizing atmosphere, and then roasting the source in a reducing atmosphere. Patent Document 2 discloses an upgrading method for a raw material for refining titanium through wet leaching, which method includes oxidizing the raw material for refining titanium and, subsequently, introducing the raw material for refining titanium and acid into a reactor, to thereby upgrade the raw material for refining titanium.

### PRIOR ART DOCUMENTS

### Patent Documents

[Patent Document 1] Japanese Patent Application Laid-Open (kokai) No. 2014-234547

[Patent Document 2] Japanese Patent Application Laid-Open (kokai) No. 2014-234548

### Non-Patent Documents

[Non-Patent Document 1] “Titanium Industry and its Prospects,” 1st edition, edited by Tadao TOMONARI, The Japan Titanium Society, Jan. 10, 2001, p. 4

### SUMMARY OF THE INVENTION

### Problems to be Solved by the Invention

However, conventionally employed wet leaching processes have problems to be solved. Specifically, the leaching efficiency is to be improved by the preliminary thermal process. Also, when the employed ilmenite ore has been less weathered (i.e., the oxidation of the ilmenite ore is insufficient), production efficiency may be impaired. Thus, a sufficiently weathered ilmenite ore is used in industrial processes, making utilization of the resource problematic.

An object of the present invention is to provide an upgrading method for an ilmenite ore, which method includes subjecting a low-TiO₂-grade ilmenite ore produced abundantly to a wet leaching process, to thereby efficiently yield a high-TiO₂-content titanium source.

### Means for Solving the Problems

The present inventors have conducted extensive studies in order to attain the above object, and have found that the ilmenite phase (FeTiO₃) in an ilmenite ore, serving as a titanium production source, is converted to two phases: a hematite phase (Fe₂O₃) and a rutile phase (TiO₂), by oxidizing the ilmenite ore at relatively low temperature, and after the oxidation process, the product is subjected to a reduction process, to thereby convert the hematite phase (Fe₂O₃) to metallic iron (Fe), followed by wet leaching after the thermal processes, whereby impurities such as iron components can be effectively dissolved and removed. As a result, a high-grade titanium production source can be yielded. The present invention has been accomplished on the basis of this finding.

Accordingly, the present invention provides the following (1) to (5):

(1) a method for upgrading an ilmenite ore for yielding a high-TiO₂-content titanium source by separating and removing an iron component from ilmenite (FeTiO₃), characterized in that the method comprises an oxidation step of oxidizing a starting ilmenite raw material; after the oxidation step, a reduction step of reducing the treated ilmenite; and after the reduction step, an extraction step of dissolving the iron component with an acid, to thereby remove the iron component;

(2) the ilmenite ore upgrading method as described in (1) above, wherein, in the oxidation step, an ilmenite phase (FeTiO₃) is converted to a hematite phase (Fe₂O₃) and a rutile phase (TiO₂), without forming a pseudo-brookite phase (Fe₂TiO₅), which is basically insoluble in acid;

(3) the ilmenite ore upgrading method as described in (2) above, wherein, in the reduction step, the hematite phase (Fe₂O₃) is reduced to metallic iron (Fe);

(4) the ilmenite ore upgrading method as described in any one of (1) to (3) above, wherein the oxidation step is performed at 600° C. to a temperature lower than 800° C.;

(5) the ilmenite ore upgrading method as described in any one of (1) to (4) above, wherein the reduction step is performed at 500° C. to 900° C.;

(6) a method for producing a high-TiO₂-content titanium source, the method comprising upgrading an ilmenite ore through an ilmenite ore upgrading method as recited in any one of (1) to (5) above; and (7) a high-TiO₂-content titanium source produced through a production method as recited in (6) above.

### Effects of the Invention

According to the present invention, an oxidation treatment is performed beforehand. In the following reduction step, an iron oxide, which is a predominant impurity present in ilmenite can be reduced to metallic iron, which is readily dissolved in acid. In the extraction step, an iron component can be readily dissolved with acid and removed. As a result, a high-TiO₂-grade ilmenite ore (TiO₂: 97 mass %) can be recovered.

Therefore, the ilmenite ore produced through the method of the present invention can be effectively used as a raw material for titanium production.

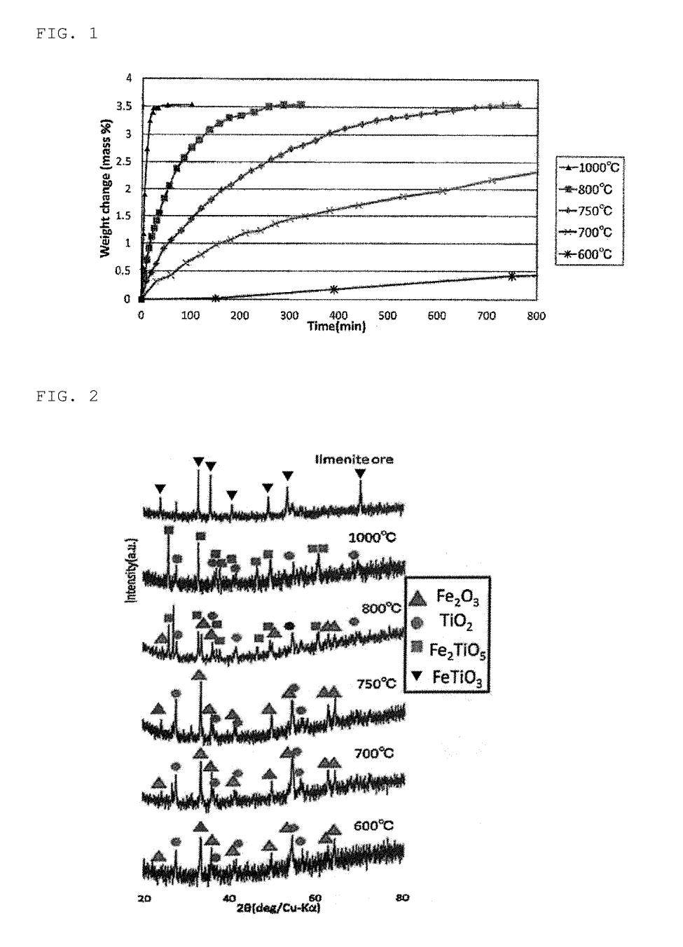

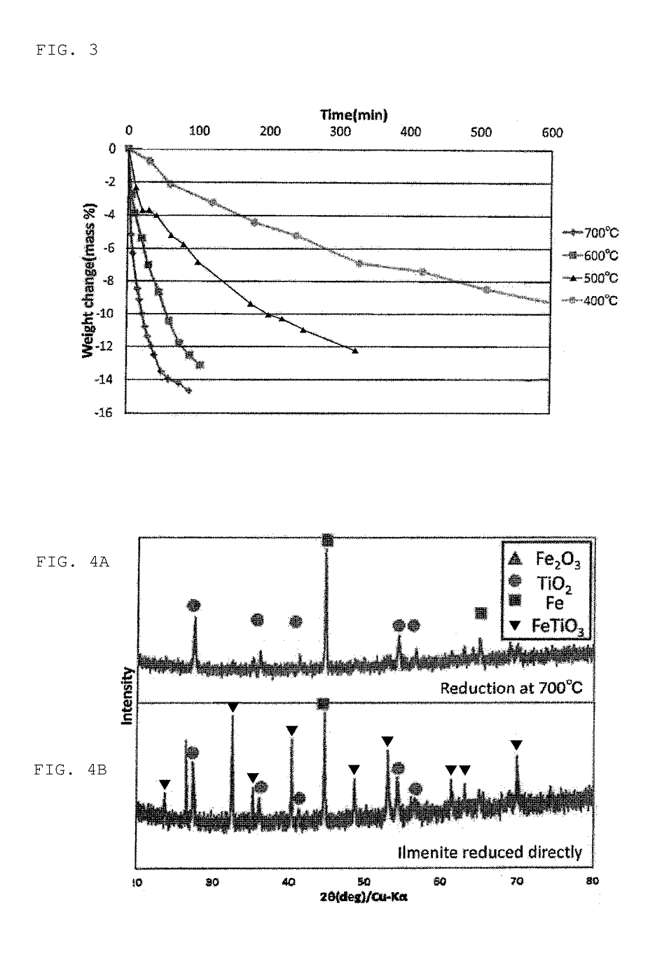

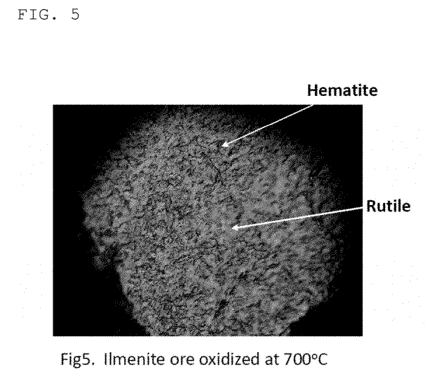

### BRIEF DESCRIPTION OF THE DRAWINGS

[FIG. 1] A graph showing a weight change profile of a starting ilmenite ore in an oxidation treatment at various specific temperatures.

[FIG. 2] A chart of XRD patterns of ilmenite ores which have undergone an oxidation treatment at various temperatures and an XRD pattern of the starting ilmenite ore.

[FIG. 3] A graph showing a weight change profile of an ilmenite ore which has undergone the oxidation treatment, in a reduction treatment at various temperatures.

[FIG. 4] An XRD pattern of an ilmenite ore which has undergone the oxidation treatment, in a reduction treatment at 700° C. (a), and that of the untreated ilmenite ore in a reduction treatment at 700° C. (b).

[FIG. 5] An SEM-EDX photograph of an ilmenite ore after oxidation at 700° C.

### DETAILED DESCRIPTION OF THE INVENTION

### Modes for Carrying Out the Invention

Embodiments of the present invention will next be described.

The method for upgrading an ilmenite ore of the present invention, for yielding a high-TiO₂-content titanium source by separating and removing a metallic component from ilmenite (FeTiO₃), includes an oxidation step of oxidizing a starting ilmenite; after the oxidation step, a reduction step of reducing the treated ilmenite; and after the reduction step, an extraction step of dissolving the metallic component with an acid, to thereby remove the metallic component.

That is, the present invention provides a method for producing (or improving) a high-TiO₂-content ilmenite ore, or for producing a high-TiO₂-grade titanium oxide, based on the aforementioned ilmenite ore upgrading method. In other words, the present invention provides a method for producing a high-TiO₂-content titanium source by separating and removing a metallic component from ilmenite (FeTiO₃), wherein the method includes an oxidation step of oxidizing a starting ilmenite; after the oxidation step, a reduction step of reducing the treated ilmenite; and after the reduction step, an extraction step of dissolving the metallic component with an acid, to thereby remove the metallic component.

The steps will next be described in detail.

### <Oxidation Step>

The starting ilmenite is a complex oxide comprising iron and titanium and has a TiO₂ content of about 30 to about 65 mass % and an iron oxide (as Fe₂O₃) content of about 30 to about 60 mass %.

In the oxidation step, the ilmenite phase (FeTiO₃) in the starting ilmenite ore, serving as a titanium production source, is converted to two phases: a hematite phase (Fe₂O₃) and a rutile phase (TiO₂), as shown in, for example, reaction scheme (1).

4FeTiO₃(s)+O₂(g)→2Fe₂O₃(s)+4TiO₂(s) Reaction scheme (1);

FIG. 5 shows an SEM-EDX photograph (an image obtained through scanning electron microscopy/energy dispersive X-ray spectroscopy) of an ilmenite ore after oxidation at 700° C. As is clear from FIG. 5, the reaction proceeds according to reaction scheme (1).

In the oxidation step of the present invention, the ilmenite phase (FeTiO₃) is converted to two phases; a hematite phase (Fe₂O₃) and a rutile phase (TiO₂), without forming a pseudo-brookite phase (Fe₂TiO₅), which is basically insoluble in acid. As a result, a metallic component (specifically, an iron (Fe) component) can be readily removed via a wet leaching process performed in the extraction step.

In the oxidation step, the starting ilmenite is preferably heated in an oxidizing atmosphere at 600° C. to a temperature lower than 800° C.

The term “oxidizing atmosphere” refers to an atmosphere containing an oxidizing gas. Examples of the atmosphere gas (oxidizing gas) employed in the oxidation step include air, oxygen, and an oxygen-inert gas mixture. The oxidation step is preferably performed in air, from the viewpoint of convenience.

Also, the partial pressure of the oxidizing atmosphere is preferably 0.01 to 0.1 MPa. When the partial pressure of the atmosphere gas in the oxidation step falls within the aforementioned range, desirable oxidation can be promoted.

As mentioned above, the temperature where the oxidation step is performed preferably falls within a range of 600° C. to a temperature lower than 800° C. When the oxidation step is performed at 600° C. or higher, decomposition (or conversion) of the ilmenite phase (FeTiO₃) to a hematite phase (Fe₂O₃) and a rutile phase (TiO₂) can be initiated. In addition, when the oxidation step is performed at a temperature lower than 800° C., the ilmenite phase can be converted to the hematite phase and the rutile phase, without forming a pseudo-brookite phase (Fe₂TiO₅), which is basically insoluble in acid. When the oxidation temperature is in excess of 800° C., reaction represented by reaction scheme (2) may preferentially occur.

4FeTiO₃(s)+O₂(g)→Fe₂O₃(s)+3TiO₂(s)+3Fe₂TiO₅(s) Reaction scheme (2);

Also, in some cases, reaction represented by reaction scheme (3) may occur at about 1,000° C.

4FeTiO₃(s)+O₂(g)→4TiO₂(s)+4Fe₂TiO₅(s) Reaction scheme (3);

Thus, the oxidation temperature is more preferably 600 to 770° C., still more preferably 600 to 750° C.

Examples of the heating technique include a fluidizing bed heating technique in which the fluidizing bed is formed under heating, and microwave radiation heating. Through employment of such a technique, processing time can be shortened.

The treatment time may be adjusted, so that titanium suboxide present in the starting ilmenite can be converted to titanium(IV) oxide. The treatment time is preferably, for example, 10 minutes to 100 hours.

Through the oxidation step of the present invention, a lower-oxidation-degree (titanium valency: <4) titanium oxide present in the starting ilmenite can be oxidized to titanium oxide (titanium valency: 4). As a result, loss of a titanium component in wet leaching performed in the extraction step, which would otherwise be caused by dissolution of a lower-oxidation-degree titanium oxide, can be effectively prevented.

### <Reduction Step>

According to the present invention, the aforementioned reduction step is performed after the oxidation step. In the reduction step, the hematite phase (Fe₂O₃) formed through the oxidation step is transformed into metallic iron (Fe).

In the present invention, the ilmenite phase (FeTiO₃) is transformed into the hematite phase (Fe₂O₃) and the rutile phase (TiO₂) in the oxidation step. According to the present invention, the hematite phase (Fe₂O₃) can be effectively reduced to metallic iron (Fe), and the reaction rate of wet leaching in the subsequent extraction step can be drastically enhanced.

In the reduction step, the ilmenite ore oxidized through the oxidation step is preferably heated in a reducing atmosphere at 500 to 900° C.

The term “reducing atmosphere” refers to an atmosphere containing a reducing gas. Examples of the atmosphere gas (reducing gas) employed in the reduction step include CO, hydrogen, and hydrocarbon gas. The reduction step is more preferably performed under hydrogen gas, from the viewpoint of reduction efficiency.

Also, the partial pressure of the reducing atmosphere is preferably 0.01 to 0.1 MPa. When the partial pressure of the atmosphere gas in the reduction step falls within the aforementioned range, reducing can be efficiently promoted.

As mentioned above, the temperature where the reduction step is preferably performed at 500 to 900° C. When the reduction step is performed at 500° C. or higher, reduction of hematite to metallic iron can be promoted, whereby the reduction step is performed at 900° C. or lower, and hematite can be reduced to iron completely.

The reduction temperature is more preferably 600 to 700° C.

Examples of the heating technique include a fluidizing bed heating technique in which the fluidizing bed is formed under heating, and microwave radiation heating. Through employment of such a technique, processing time can be shortened.

The treatment time may be adjusted to an appropriate period of time, depending on the target titanium grade of the source. The treatment time is preferably, for example, 10 minutes to 100 hours.

In the present invention, when the reduction step is performed after the oxidation step, the hematite phase (Fe₂O₃) is reduced to metallic iron (Fe). In this case, the iron component volume changes, to thereby provide micropores communicating from the surface to the core of ore particles. By virtue of the micropores, the wet leaching reaction rate in the extraction step can be drastically enhanced.

When no oxidation step is performed, the ilmenite phase (FeTiO₃) is not sufficiently reduced. However, when the oxidation step is performed before the reduction step, the ilmenite phase can be effectively reduced to metallic iron (Fe) in the reduction step, whereby the wet leaching reaction rate in the subsequent extraction step can be drastically enhanced.

### <Extraction Step>

According to the present invention, after the reduction step, an extraction step of treating (wet-leaching) the reduced product with acid is performed. In the extraction step, impurities such as an iron component are dissolved in the acid for removal, to thereby yield a high-grade ilmenite ore. Also, the thus-removed iron component and the like are employed as a material of recovering iron.

The acid employed in the extraction step may be at least one species selected from an inorganic acid and an organic acid. Examples of the inorganic acid include hydrochloric acid, nitric acid, sulfuric acid, phosphoric acid, and hydrofluoric acid. Examples of the organic acid include formic acid and citric acid. Among these acids, an inorganic acid is preferably used, from the viewpoint of iron solubility. Hydrochloric acid is more preferred, since it has high solubility selective to iron.

The acid concentration employed in the extraction step is preferably adjusted to 10 to 35 mass % in an extraction treatment liquid. When the extraction treatment liquid has an acid concentration of 10 mass % or higher, iron solubility can be enhanced. The upper limit of the acid concentration of the extraction treatment liquid may be appropriately tuned in consideration of the acid concentration at saturation. In the case of hydrochloric acid, the saturation concentration is about 35 mass %. The upper limit of the acid concentration of the extraction treatment liquid is preferably 20 mass % or lower.

In one mode of the extraction technique, an ilmenite ore which has undergone the reduction step is brought into contact with an acid-containing treatment liquid, to thereby allow the ilmenite ore to react with the acid. Examples of the above contact technique include immersing and statically placing the ilmenite ore in the treatment liquid; adding the ilmenite ore into a container filled with the treatment solution and mixing the contents under stirring; and adding the ilmenite ore into the treatment solution and applying pressure to the mixture (pressurizing with hydrochloric acid vapor).

The temperature employed in the extraction step is preferably 100° C. or higher, more preferably 130° C. or higher, still more preferably 130 to 150° C. Through performing the extraction step at 100° C. or higher, extraction performance can be enhanced.

The pressure employed in the extraction step is preferably at least atmospheric pressure, more preferably 0.01 to 0.4 MPa. Through performing the extraction step at atmospheric pressure or higher, extraction can be efficiently performed. No particular limitation is imposed on the extraction time, so long as extraction is sufficiently completed. For example, the extraction time is preferably 1 to 3 hours, more preferably 1 to 2 hours.

According to the present invention, the ilmenite phase (FeTiO₃) is converted to the hematite phase (Fe₂O₃) and the rutile phase (TiO₂) in the oxidation step, and the hematite phase (Fe₂O₃) is reduced to metallic iron (Fe) in the subsequent reduction step. Thus, the iron component volume changes after the oxidation/reduction steps, to thereby provide micropores connecting from the surface to the core of ilmenite ore particles. By virtue of the micropores, the reaction rate in the extraction step can be drastically enhanced. As a result, the extraction step proceeds at high rate, to yield a high-TiO₂-content ilmenite ore (upgrade ilmenite: UGI).

Thus, the high-TiO₂-content titanium source produced by the high-TiO₂-content titanium source production method employing the ilmenite ore upgrading method has a physical structure in which micropores connecting from the surface to the core of ilmenite ore particles are provided.

The high-TiO₂-content ilmenite ore produced through the present invention preferably has a TiO₂ content of 95 mass % or higher, more preferably 97 mass % or higher. Thus, a titanium production source can be upgraded effectively and efficiently through the method of the present invention. As used herein, the term “upgrading” refers to elevating the TiO₂ concentration of the titanium source to a level higher than the TiO₂ concentration of the non-treated ore. In some cases, the “upgrading” may refer to attaining a preferred TiO₂ content of 95 mass % or higher.

Meanwhile, in the present invention, the gas generated during the treatment of ilmenite ore performed in the extraction step is preferably separated into hydrogen gas and hydrochloric acid gas. Preferably, the thus-recovered hydrogen gas is reused in the reduction step, and the hydrochloric acid gas is reused in the extraction step.

### EXAMPLES

The present invention will next be described in more detail by way of examples and comparative examples.

Although the present invention will next be described in detail by way of examples, the examples are given only for the purpose of illustration and should not be construed as limiting the scope of the invention thereto.

In order to confirm the effect(s) of the ilmenite upgrading method of the present invention, the following tests were conducted.

### Test Example 1

An ilmenite ore having a TiO₂ grade of about 50 mass % was used as a starting material and subjected to an oxidation treatment. The starting material was oxidized in air at five different temperatures; 600° C., 700° C., 750° C., 800° C., and 1,000° C., respectively. In each case, the change in weight over time was measured. Also, ilmenite ore samples which had been sufficiently oxidized to exhibit no substantial weight increase and the starting ilmenite ore were analyzed through X-ray diffractometry. X-ray diffractometery (XRD) was performed by means of a powder X-ray diffractometer “D8 ADVANCE” (product of BRUKER, X-ray source: Cu-Kα). FIG. 1 shows a weight change profile of an ilmenite ore in the oxidation treatment at different temperatures. FIG. 2 shows X-ray diffraction patterns (XRD patterns) of the ilmenite ore samples after the oxidation treatment at different temperatures and an XRD pattern of the original ilmenite ore.

As shown in FIG. 1, increase in weight substantially stopped when the percent change in weight reached about 3.5 mass %. Thus, oxidation reaction is conceivably terminated around the above percent change in weight.

Also, as shown in FIG. 2, when the ilmenite ore samples were oxidized at 800° C. and 1,000° C., a peak attributed to pseudo-brookite (Fe₂TiO₅), which is slightly soluble in acid, was identified. When the oxidation treatment was performed at 750° C. or lower, no such peak was observed. As a result, the oxidation treatment is preferably performed at a temperature lower than 800° C., more preferably at 600 to 750° C.

### Test Example 2

The ilmenite ore sample which had undergone the oxidation treatment at 750° C. in Test Example 1 was used and further subjected to a reduction treatment. The sample was subjected to a reduction treatment under hydrogen gas at four different temperatures; 400° C., 500° C., 600° C., and 700° C., respectively. In each case, the change-over-time in weight of the ilmenite ore was measured. FIG. 3 shows the weight change profile of the ilmenite ore.

Separately, an ilmenite ore sample which had undergone the reduction treatment at 700° C. and had been sufficiently reduced to exhibit no substantial weight decrease was analyzed through X-ray diffractometry. Also, in order to assess the effect of the oxidation treatment, an ilmenite ore which had undergone no oxidation treatment was subjected to a reduction treatment under hydrogen gas at 700° C. for 30 minutes. Then, the sample was analyzed through X-ray diffractometry. X-ray diffractometery (XRD) was performed by means of a powder X-ray diffractometer “D8 ADVANCE” (product of BRUKER, X-ray source: Cu-Kα). FIG. 4 shows XRD patterns of the ilmenite ore sample after the reduction treatment and the ilmenite ore sample which has undergone the reduction treatment but no oxidation treatment.

As shown in FIG. 3, decrease in weight substantially stopped when the percent change in weight decreased to about 14 mass %. Thus, conceivably reduction reaction is substantially terminated around the above percent change in weight.

As is clear from FIG. 4(a), through the oxidation step, the iron component contained in the ore is reduced to metallic iron, which is readily soluble in acid. In contrast, as shown in FIG. 4(b), when no oxidation treatment was performed, the ilmenite crystal phase remained in the ore, clearly indicating a drop in leaching efficiency in a subsequent step. Thus, the oxidation treatment prior to the reduction treatment was found to be an essential step.

### Test Example 3

### Example 1

The ilmenite ore sample which had undergone the oxidation treatment at 750° C. in Test Example 1 was subjected to a reduction treatment under hydrogen gas at 700° C. for 3 hours. The thus-treated ilmenite ore sample (10 g) was used. The ilmenite ore sample (10 g) was mixed with 18% hydrochloric acid as a treatment liquid (50 cc), and the mixture was maintained in air at 150° C. (a heater's temperature), whereby wet leaching was performed for 1 hour. After leaching, the composition of the ilmenite ore sample was determined through ICP analysis (Shimadzu Corporation). Table 1 shows the result of analysis.

### Comparative Example 1

A synthetic rutile UGI (product of DCW) recovered in India, which is a product (a commercial product) obtained through a leaching treatment of an ilmenite ore through the Benilite process, was subjected to ICP compositional analysis (Shimadzu Corporation). Table 1 shows the results.

### Comparative Example 2

A synthetic rutile (SREP, product of ILUKA) recovered in Australia, which is a product (a commercial particle) obtained through a leaching treatment of an ilmenite ore through the Beacher process, was subjected to an ICP compositional analysis (Shimadzu Corporation). Table 1 shows the results.

### Referential Example 1

The ilmenite ore, serving as the original ore sample (TiO₂ grade: about 50 mass %), was subjected to the same compositional analysis procedure as employed in Example 1. Table 1 shows the results.

TABLE 1
Compositional analysis of ore samples and ore products (unit: mass %)

| | TiO₂ | Fe | FeO | Fe₂O₃ | MnO | SiO₂ | Al₂O₃ | others |
|---|---|---|---|---|---|---|---|---|
| Ref. Ex. 1 | 49.7 | — | 31.24 | 14.85 | 2.26 | 1.1 | 0.44 | 0.42 |
| Ex. 1 | 97.05 | 0.55 | — | — | 0.29 | 0.67 | 0.82 | 0.62 |

| | | | | | | |
|---|---|---|---|---|---|---|
| Comp. Ex. 1 | 94.17 | 1.88 (as total Fe) | 0.06 | 1.71 | 0.39 | 0.69 |
| Comp. Ex. 2 | 92.72 | 1.72 (as total Fe) | 0.69 | 2.96 | 0.84 | 2.16 |

As shown in Table 1, the ore sample of Example 1 has a TiO₂ quality considerably higher than that of a conventional synthetic rutile (UGI). Thus, according to the method of the present invention, a high-TiO₂-content ilmenite ore was found to be obtained.

### Test Example 4

The procedure of Test Example 2 was repeated, except that the reduction treatment was performed at different temperatures; 400° C., 500° C., 600° C., and 700° C., respectively. The thus-treated ilmenite ore sample (10 g) was used. The ilmenite ore sample (10 g) was mixed with 18% hydrochloric acid as a treatment liquid (50 cc), and the mixture was maintained in air at 150° C. (a heater's temperature), whereby wet leaching was performed for 1 hour. After leaching, the composition of the ilmenite ore sample was determined through ICP analysis (Shimadzu Corporation). Table 2 shows the result of analysis.

TABLE 2
Composition of HCl solution after leaching (unit: mass %)

| | | Ti | Fe | Mn | Si | Al |
|---|---|---|---|---|---|---|
| Reduction | 400° C. | 8.56 | 37.7 | 1.71 | 0.16 | 0.02 |
| temperature | 500° C. | 7.97 | 39.73 | 1.72 | 0.21 | 0.02 |
| | 600° C. | 4.92 | 39.72 | 1.73 | 0.23 | 0.02 |
| | 700° C. | 2.61 | 40.45 | 1.68 | 0.14 | 0.14 |

As is clear from Table 2, a sample which had undergone a reduction treatment at 700° C. exhibited the largest iron component amount after the treatment with hydrochloric acid treatment. That is, the amount of loss of the titanium component was the smallest. As a result, the reduction temperature is suitably set at about 700° C.

1. A method for upgrading an ilmenite ore for yielding a high-TiO₂-content titanium source by separating and removing an iron component from ilmenite (FeTiO₃), characterized in that the method comprises an oxidation step of oxidizing a starting ilmenite;
after the oxidation step, a reduction step of reducing the treated ilmenite; and after the reduction step, an extraction step of dissolving the iron component with an acid, to thereby remove the iron component.

2. The ilmenite ore upgrading method as claimed in claim 1, wherein, in the oxidation step, an ilmenite phase (FeTiO₃) is converted to a hematite phase (Fe₂O₃) and a rutile phase (TiO₂), without forming a pseudo-brookite phase (Fe₂TiO₅), which is basically insoluble in acid.

3. The ilmenite ore upgrading method as claimed in claim 2, wherein, in the reduction step, the hematite phase (Fe₂O₃) is reduced to metallic iron (Fe).

4. The ilmenite ore upgrading method as claimed in claim 1, wherein the oxidation step is performed at 600° C. to a temperature lower than 800° C.

5. The ilmenite ore upgrading method as claimed in claim 1, wherein the reduction step is performed at 500° C. to 900° C.

6. A method for producing a high-TiO₂-content titanium source, the method comprising upgrading an ilmenite ore through an ilmenite ore upgrading method claimed in claim 1.

7. A high-TiO₂-content titanium source produced through a production method as claimed in claim 6.
